(19) United States
(12) Patent Application Publication
(10) Pub. No.: US 2006/0093744 A9
(43) Pub. Date: May 4, 2006

(54) Surface treatment process for magnesium-based material

(75) Inventors: Hideyuki Suzuki, Kariya-city (JP); Koichiro Sato, Kariya-city (JP); Keiichi Okazaki, Ichinomiya-city (JP); Tomoko Ito, Nagoya-city (JP); Hiroshi Kawaguchi, Kariya-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/178,190

(22) Filed: Jul. 8, 2005

(30) Foreign Application Priority Data
Jul. 12, 2004 (JP) 2004-204957

(51) Int. Cl. B05D 3/02

(52) U.S. Cl. 427/377

(57) ABSTRACT

A process for providing a coating on a surface of a substrate made of magnesium or magnesium alloy has a step of heating the substrate in a humidified atmosphere therein. It is desirable that the atmosphere has a temperature between 50 and 450 degrees centigrade and a relative humidity between 50 and 100%. It is also desirable that the atmosphere has a pressure between 1.0×10⁵ and 1.0×10⁶ Pa. Further, it is desirable that a thickness of the coating is between 3 and 50 μm. The surface treatment process is suitable for forming a vehicular part such as an ECU case.

### CROSS REFERENCE TO RELATED APPLICATION

This application is based on Japanese Patent Application No. 2004-204957 filed on Jul. 12, 2004, the content of which is incorporated herein by reference.

### FIELD OF THE INVENTION

The present invention relates to a surface treatment process for a magnesium-based material (in this description, both magnesium and magnesium alloys will be hereinafter comprehensively referred to as “magnesium-based material”).

### BACKGROUND OF THE INVENTION

Magnesium-based materials such as magnesium and magnesium alloys have high stiffness than resinous materials and shielding performance against electromagnetic interferences (EMI), so that they have been applied to materials for electronic appliances such as cellular phones and personal computers. Especially, magnesium-based materials are the lightest ones among practically used metals and therefore, there have been tried to apply them in vehicular parts to decrease vehicular weight and to improve fuel efficiency.

However, magnesium, among practically used metals, is the most active metal material and accordingly, a surface treatment in accordance with an usage condition is necessary because of their low corrosion resistance. As surface-treating methods for improving the corrosion resistance of magnesium-based materials, there have conventionally been used, for instance, chemical conversion treatments, anodization treatments and coating/plating techniques.

JP-2002-220697-A, for instance, discloses a surface-treating method to grow a highly corrosion-resistant film mainly consisting of magnesium oxide on magnesium-based material. The method includes alkaline electrolysis with a polarity inversion power supply outputting each of positive and negative power alternately and periodically. It electronically forms a magnesium oxide film during positive polarity of alkaline electrolysis and smoothes the magnesium oxide film by an action similar to electrolytic polishing during negative polarity.

JP-2002-275687-A discloses another surface-treating method to form a coated member consisting of magnesium-based substrate, an oxidized layer (magnesium oxide) formed on the magnesium-based substrate and a coating layer that are oxides or sulfides of the group VIa elements and formed on the oxidized layer.

The surface-treating methods disclosed in JP-2002-2200697-A and JP-2002-275687-A can form a highly corrosion-resistant coating on magnesium-based material. The methods, however, costs much because they require special chemicals and processes. These expensive surface-treating methods are bottlenecks to apply magnesium-based material to many purposes such as vehicular parts.

### SUMMARY OF THE INVENTION

The present invention, in view of the above-described issue, has an object to provide a surface treatment process for magnesium-based material capable of forming a highly corrosion-resistant coating on the magnesium-based material at a relatively small cost and especially suitable for forming a magnesium-based member used for vehicular parts.

The process for providing a coating on a surface of a substrate made of magnesium-based material has at least a step of heating the substrate in a humidified atmosphere. It is desirable that the atmosphere has a temperature between 50 and 450 degrees centigrade and a relative humidity between 50 and 100%. It is also desirable that the atmosphere has a pressure between 1.0×10⁵ and 1.0×10⁶ Pa. Further, it is desirable that a thickness of the coating provided on the surface is between 3 and 50 μm.

### BRIEF DESCRIPTION OF THE DRAWINGS

Features and advantages of embodiments will be appreciated, as well as methods of operation and the function of the related parts, from a study of the following detailed description, the appended claims, and the drawings, all of which form a part of this application. In the drawings:

FIG. 1A is an explanatory view schematically showing a test specimen surface-treated by a surface treatment process according to an embodiment of the present invention;

FIG. 1B is an explanatory view schematically showing a furnace and pressure-tight container for realizing a humidified atmosphere in the surface treatment process according to the embodiment;

FIG. 1C is a microscope photograph showing a cross-section of a magnesium-based substrate surface-treated by the surface treatment process according to the embodiment; and

FIG. 1D is an explanatory diagram of the microscope photograph of FIG. 1C.

### DETAILED DESCRIPTION OF PREFERRED EMBODIMENTS

In the following is described an embodiment of a surface treatment process for a magnesium-based material according to the present invention. The surface treatment process forms a coating on a surface of a substrate made of magnesium or magnesium alloy by heating the substrate in a humidified atmosphere.

The coating on the surface of the substrate formed by the surface treatment process according to the present invention is highly corrosion-resistant and has high hardness and dark color. In addition, the process can form the coating of magnesium oxide in shorter period of time than a heating process in a non-humidified atmosphere so as to decrease a cost of the surface treatment process.

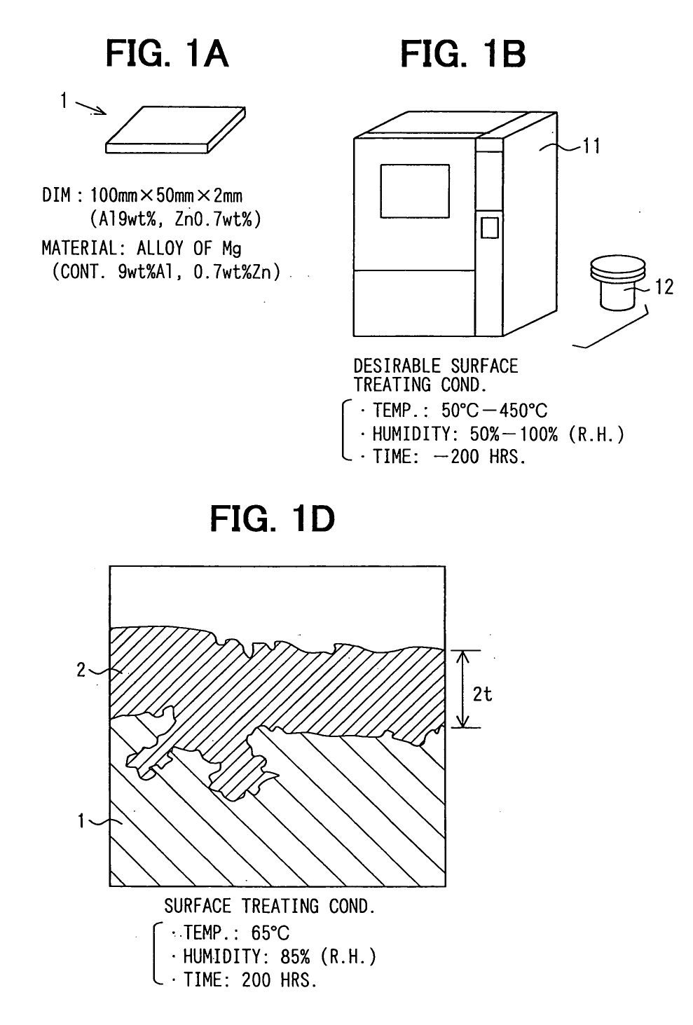

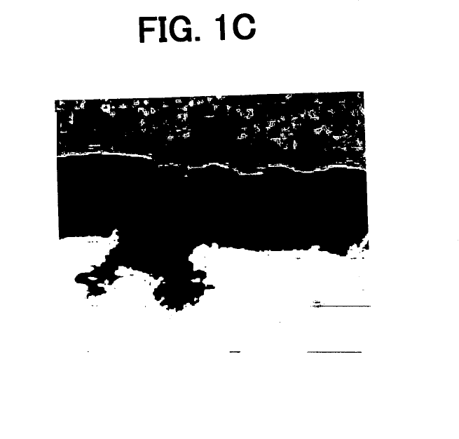

FIG. 1A depicts a test specimen 1 made of magnesium alloy ASTM AZ91D, which includes 9 wt % of aluminum and 0.7 wt % of zinc and measures 100×50×2 mm. The test specimen 1 is disposed in a pressure-tight container 12 together with water. Then the pressure-tight container 12 is kept in a constant temperature furnace 11. According to the above-described test, a condition of the surface treatment process at a temperature between 50 degrees centigrade and 450 degrees centigrade and a relative humidity between 50% and 100% is suitable for controlling a thickness of the coating of magnesium oxide formed on the specimen 1. Such a condition that the atmosphere including a fine water mist is an example having the relative humidity of 100%.

FIGS. 1C and 1D depict a microscope photographic image (a scanning ion microscope image) of a section of the specimen 1 after the above-described surface treatment process executed at a temperature of 65 degrees centigrade, at a relative humidity of 85% and for 200 hours. FIGS. 1C and 1D depict a magnesium oxide coating 2 having a relatively constant thickness 2t of approximately 3 μm.

It is desirable that the thickness of the magnesium oxide coating formed on the substrate is between 3 μm and 50 μm. The magnesium oxide coating not thinner than 3 μm can secure an stable corrosion-resistance for a long period of time. The magnesium oxide coating not thicker than 50 μm can shorten the heating process time so as not to form an excessively thick coating and so as to decrease the cost of the process.

The surface treatment process according to the present invention may be executed with a constant temperature/humidity furnace, a steam process apparatus, an autoclave and so on instead of the furnace 11 and the pressure-tight container 12 as shown in FIG. 1B. It is desirable to set the pressure of the process atmosphere between 1.0×10⁵ Pa and 1.0×10⁶ Pa to form a stable magnesium oxide coating on the substrate. The above-described pressure condition can form the magnesium oxide coating in a shorter period of time than in non-pressurized atmosphere.

Especially, the above-described surface treatment process is suitable for a surface treatment of a magnesium materials used for vehicular parts, which requires a high corrosion-resistance such as a relatively large and complex shaped engine block and a transmission case to decrease weights thereof. The above-described surface treatment process can be applied even to a large and complex shaped vehicular parts made of magnesium-based materials without increasing a surface treatment cost and without spoiling the quality of the magnesium oxide coating.

The surface treatment process according to the present invention is also suitable for a surface treatment of a magnesium member used for an electronic control unit (ECU) case for vehicle, which should have relatively light weight and high shielding performance against EMI. The ECU case made of the magnesium substrate with a magnesium oxide coating formed by the surface treatment process can be light and high shielding performance relative to those made of resinous materials. Further, the surface treatment process according to the present invention can be applied to surface treatments of substrates or works made of magnesium-based material and shaped by casting, machining, stamping and the like, which are suitable for shaping magnesium-based material.

This description of the invention is merely exemplary in nature and, thus, variations that do not depart from the gist of the invention are intended to be within the scope of the invention. Such variations are not to be regarded as a departure from the spirit and scope of the invention.

What is claimed is:

1. A process for providing a coating on a surface of a substrate made of magnesium or magnesium alloy comprising a step of heating the substrate in a humidified atmosphere.

2. The process according to claim 1, wherein:
the atmosphere has a temperature between 50 degrees centigrade and 450 degrees centigrade and a relative humidity between 50% and 100%.

3. The process according to claim 1, wherein the atmosphere has a pressure between 1.0×10⁵ Pa and 1.0×10⁶ Pa.

4. The process according to claim 1, wherein a thickness of the coating is between 3 μm and 50 μm.

5. The process according to claim 1, wherein the substrate is shaped for a part of a vehicle.
